(19) United States
(12) Patent Application Publication
(10) Pub. No.: US 2005/0031186 A1
(43) Pub. Date: Feb. 10, 2005

(54) Systems and methods for characterizing a three-dimensional sample

(76) Inventors: Victor Van Luu, Morgan Hill, CA (US); Don Van Tran, Morgan Hill, CA (US)

Correspondence Address: TRAN & ASSOCIATES, 6768 MEADOW VISTA CT., SAN JOSE, CA, 95135, US

(21) Appl. No.: 10/638,630

(22) Filed: Aug. 10, 2003

(51) Int. Cl. G06K 9/00

(52) U.S. Cl. 382/141; 382/154

(57) ABSTRACT

Systems and methods are disclosed to characterize a sample by capturing a plurality of perspective images of the sample; dividing the perspective images into one or more sub-lines; and three-dimensionally characterizing the sample based on the sub-line analysis.

### BACKGROUND

This application is also related to Application Serial No. 10/______ entitled “METHOD AND APPARATUS FOR PROVIDING NANOSCALE DIMENSIONS TO SEM (SCANNING ELECTRON MICROSCOPY) OR OTHER NANOSCOPIC IMAGES” and Serial No. 10/______ entitled “SYSTEMS AND METHODS FOR CHARACTERIZING A SAMPLE”, all with common inventorship and common filing date, the contents of which are hereby incorporated by reference.

This invention relates generally to a method for characterizing a 3D sample.

Advances in computing technology and imaging technology have provided engineers and scientists with volumes of data. However, data and information are fundamentally different from each other. Rows and columns of data in the form of numbers and text can obscure, in the sense that its relevant attributes and relationships are hidden. Normally, the user works with a variety of tools to discover such data relationships.

One approach to increasing comprehension of data is data visualization. Data visualization utilizes tools such as display space plots to represent data within a display space defined by the coordinates of each relevant data dimensional axis.

Many applications involve structures that have nano-level or atomic level scale. In one example, in the semiconductor applications, deposited films need to be characterized. Integrated circuits are made up of layers or films deposited onto a semiconductor substrate, such as silicon. The films include metals to connect devices formed on the chip. A metal film contains crystal grains with various distributions of sizes and orientations. The range of sizes may be narrow or broad, and a distribution of grain sizes may have a maximum at some size and then decrease monotonically as the size increases or decreases. Alternatively, there may be a bi-modal distribution so that there is a high concentration of grains in two different ranges of size. The grain size affects the mechanical and electrical properties of a metal film.

The semiconductor fabrication process needs to be closely monitored in order to avoid unacceptable wafer losses through out-of-spec results. One direct monitoring technique uses scanning electron microscopy (SEM). An SEM image contains information on the surface topology. Evaluating this information is, however, tedious process.

### SUMMARY

Systems and methods are disclosed to characterize a sample by capturing a plurality of perspective images of the sample; dividing the perspective images into one or more sub-lines; and three-dimensionally characterizing the sample based on the sub-line analysis.

Advantages of the system may include one or more of the following. The system provides an automated method of characterizing images. The method for grain size determination is non-destructive, can measure the grain size within a small area of film, and can give results in a short period of time. For the semiconductor defect analysis application, characteristics of the image data are quantified numerical values so that computer as well as human can interpret the information. The system enhances efficiency by minimizing the need for a person to observe or review the image.

### BRIEF DESCRIPTION OF THE DRAWINGS

FIG. 1 illustrates an exemplary method to characterize a sample in 3D.

FIG. 2A illustrates an exemplary method to process images of the sample.

FIG. 2B illustrates the operation of an exemplary horizontal line analysis.

FIG. 3 illustrates an exemplary method to dynamically analyze sample images.

FIG. 4 shows an exemplary embodiment for semiconductor defect control.

FIG. 5 shows an exemplary data processing system to perform dynamic analysis.

FIG. 6 shows an exemplary system to build a model.

FIG. 7 shows an exemplary system that to apply a model to perform process control.

FIG. 8 is one implementation of the process control system of FIG. 7.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

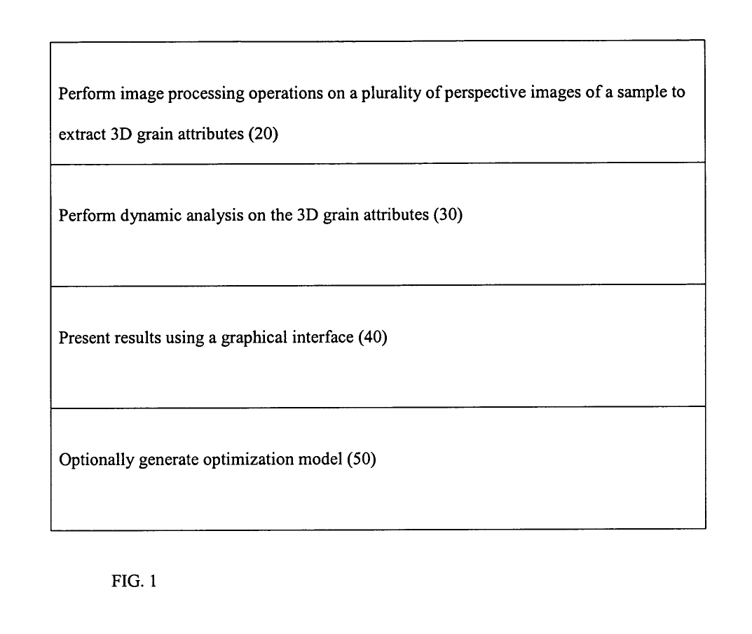

FIG. 1 illustrates an exemplary method 10 to characterize a sample. First, image processing operations are performed on a plurality of perspective images or stereoscopic images of a sample (20). In one embodiment, the sample can be a semiconductor being manufactured and images can be digital pictures taken by a scanning electron microscope (SEM). The creation of a 3D model is depending on the quality of input images. In one embodiment, the images are not saturated (at least not in large areas). A saturated image is an image where many of the gray values are bright white. In such areas all the image content will be lost. The images are processed and the grain's attributes are stored in a database or a file, analysis such as statistical and data mining analysis is performed on the grain attributes (30). The method 10 also presents the results using a graphical interface (40). Next, the method 10 generates a predictive model that can be used to optimize the wafer manufacturing process (50).

In taking the perspective images, the object such as a wafer specimen is eucentrically tilted to the right around the vertical axis. The principal axis and the tilt axis should intersect at a point on top of the surface. Thus a tilting results in a static center point in the image. In the non ideal case the principal axis and the tilt axis do not intersect on top of the surface, but below or above the point. A non ideal tilting results in a migration of the center point in the image (sideways in the case of vertical tilting and vertical in the case of horizontal tilting). The following procedure is used for tilting the wafer:
Before tilting mark the center point of the image (which should be a significant structure) on the screen.
Tilt until the significant structure is almost vanishing at the image border.
Adjust the position of the specimen such that the significant structure is again in the center point of the image.
Readjust if the working distance has changed and repeat until the desired tilt angle is reached.

The total relative tilt angle between the left and right image should be within the range 2 to 14 degrees. The above eucentric tilting should be repeated for various different directions, for example the specimen should be tilted to the left (in the case of a vertical tilt axis) or upwards (in the case of a horizontal tilt axis). In one embodiment, two images are captured that are symmetrically to the ground plane. The relative tilt angle between the left and the right image should be measured as exactly as possible. An error in the tilt angle is the most prominent source of inaccuracy affecting the 3D model.

The plurality of perspective images of the same sample area, taken at a plurality of angles, are analyzed to identify tips of all structures in the images. For a mathematical reconstruction of the complete surface, all structure facets are determined. Each facet of each structure is viewed as a polygon with all points lying in the same oriented plane. A set of all polygons representing a mathematical reconstruction of the full surface topology is determined using algorithms known in the art, for example the algorithm described in “Reconstruction of the Surface Topography of Randomly Textured Silicon” by Gregor Kuchler and Rolf Brendel, the content of which is incorporated by reference.

The identified structures can be used to generate 3D models that can be viewed using 3D CAD tools. In one embodiment, a 3D geometric model in the form of a triangular surface mesh is generated. In another implementation, the model is in voxels and a marching cubes algorithm is applied to convert the voxels into a mesh, which can undergo a smoothing operation to reduce the jaggedness on the surfaces of the 3D model caused by the marching cubes conversion. One smoothing operation moves individual triangle vertices to positions representing the averages of connected neighborhood vertices to reduce the angles between triangles in the mesh. Another optional step is the application of a decimation operation to the smoothed mesh to eliminate data points, which improves processing speed. After the smoothing and decimation operation have been performed, an error value is calculated based on the differences between the resulting mesh and the original mesh or the original data, and the error is compared to an acceptable threshold value. The smoothing and decimation operations are applied to the mesh once again if the error does not exceed the acceptable value. The last set of mesh data that satisfies the threshold is stored as the 3D model. The triangles form a connected graph. In this context, two nodes in a graph are connected if there is a sequence of edges that forms a path from one node to the other (ignoring the direction of the edges). Thus defined, connectivity is an equivalence relation on a graph: if triangle A is connected to triangle B and triangle B is connected to triangle C, then triangle A is connected to triangle C. A set of connected nodes is then called a patch. A graph is fully connected if it consists of a single patch. The processes discussed below keep the triangles connected. The mesh model can also be simplified by removing unwanted or unnecessary sections of the model to increase data processing speed and enhance the visual display. Unnecessary sections include those not needed for creation of the tooth repositioning appliance. The removal of these unwanted sections reduces the complexity and size of the digital data set, thus accelerating manipulations of the data set and other operations. The system deletes all of the triangles within the box and clips all triangles that cross the border of the box. This requires generating new vertices on the border of the box. The holes created in the model at the faces of the box are retriangulated and closed using the newly created vertices. The resulting mesh can be viewed and/or manipulated using a number of conventional CAD tools.

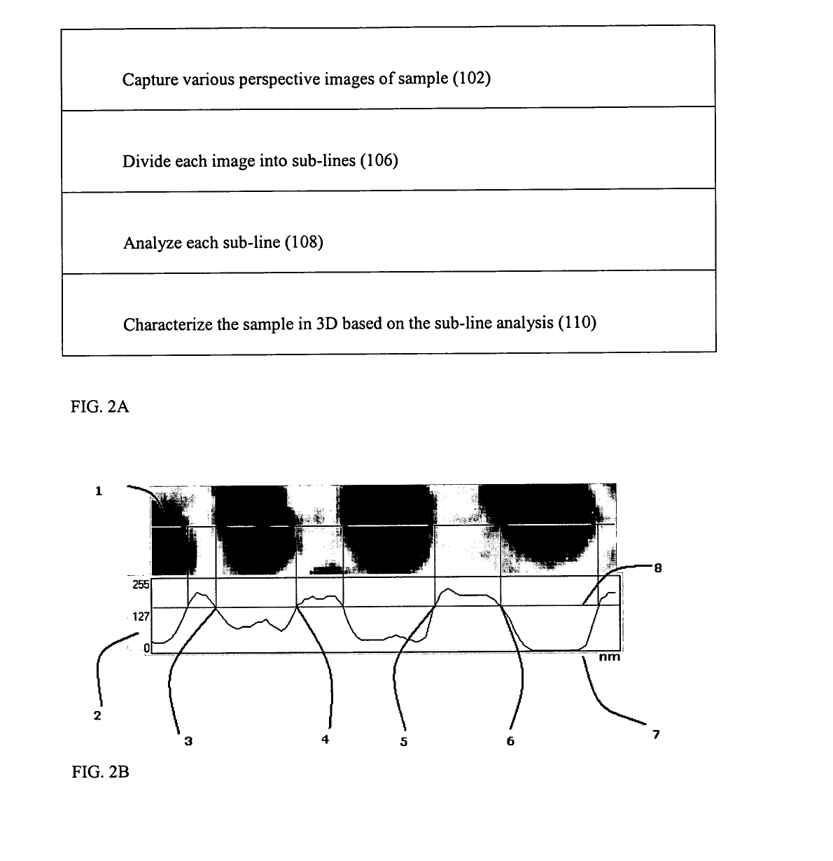

FIG. 2A illustrates an exemplary method 100 to process the image of the sample. In this process, images are calibrated using a scale bar in the images to pixels, grains are processed into spatial objects, and grain's data are written into file storages. The method 100 acquires a plurality of perspective images of the sample and calibrates the images using the scale bar (102). Images can be stored in JPEG, TIFF, GIF or BMP format, among others. Each perspective images in turn is divided into a plurality of sub-lines (106). The method 100 then analyzes each sub-line for objects, spots or grains (108) and characterizes the sample based on the sub-line analysis (110).

Pseudo-code for horizontal line analysis is as follows:
1. Horizontal lines are drawn in the specimen.
2. Each pixel on the line is converted to the gray scale value and store in a matrix corresponding to pixel's coordinate.
3. Pixel location intersect with line, depicting the average edge line.
4. The distance between and is the grain size on line.
5. The distance between the two boundaries is the empty space on line.
6. Line is the distance of line after spatial calibration.
7. Line is average edge line using average edge line detection.

Turning now to FIG. 2B, an example of the operation of the above pseudo-code is illustrated. First, horizontal lines (1) are drawn in the specimen. Next, each pixel on the line is converted to the gray scale value (2) and store in a matrix corresponding to pixel's coordinate. The pixel location (3) intersects with line (8), depicting the average edge line. The distance between (3) and (4) is the grain size on line (1). The distance between (5) and 6) is the empty space on line (2). The line (7) is the distance of line (1) after spatial calibration, while line (8) is average edge line using average edge line detection.

Alternatively, vertical line analysis can be done. Pseudo-code for horizontal line analysis is as follows:
1. Vertical lines are drawn in the specimen.
2. Each pixel on the line is converted to the gray scale value and store in a matrix corresponding to pixel's coordinate.
3. Pixel location intersect with line, depicting the average edge line.
4. The distance between and is the grain size on line.
5. The distance between the two boundaries is the empty space on line.
6. Line is the distance of line after spatial calibration.
7. Line is average edge line using average edge line detection.

In 108, each sub-line image is converted into a grain's spatial attributes—perimeter, radius, area, x-vertices, y-vertices, among others. The analysis performed in 108 includes one or more of the following:

Area: The area of the object, measured as the number of pixels in the polygon. If spatial measurements have been calibrated for the image, then the measurement will be in the units of that calibration.

Perimeter: The length of the outside boundary of the object, again taking the spatial calibration into account.

Roundness: Computed as:
(4×PI×area)/perimeter²

The value will be between zero and one—The greater the value, the rounder the object. If the ratio is equal to 1, the object will a perfect circle, as the ratio decreases from one, the object departs from a circular form.

Elongation: The ratio of the length of the major axis to the length of the minor axis. The result is a value between 0 and 1. If the elongation is 1, the object is roughly circular or square. As the ratio decreases from 1, the object becomes more elongated.

Feret Diameter: The diameter of a circle having the same area as the object, it is computed as:
✓(4×area/PI).

Compactness: Computed as:
✓(4×area/PI)/major axis length

This provides a measure of the object's roundness. Basically the ratio of the feret diameter to the object's length, it will range between 0 and 1. At 1, the object is roughly circular. As the ratio decreases from 1, the object becomes less circular.

Major Axis Length: The length of the longest line that can be drawn through the object. The result will be in the units of the image's spatial calibration.

Major Axis Angle: The angle between the horizontal axis and the major axis, in degrees.

Minor Axis Length: The length of the longest line that can be drawn though the object perpendicular to the major axis, in the units of the image's spatial calibration.

Minor Axis Angle: The angle between the horizontal axis and the minor axis, in degrees.

Centroid: The center point (center of mass) of the object. It is computed as the average of the x and y coordinates of all of the pixels in the object.

Height: The height of the object.

In one embodiment of operation 110, the method 100 stores grain's information in tabular format, text delimited files, spreadsheet (Excel) files or database.

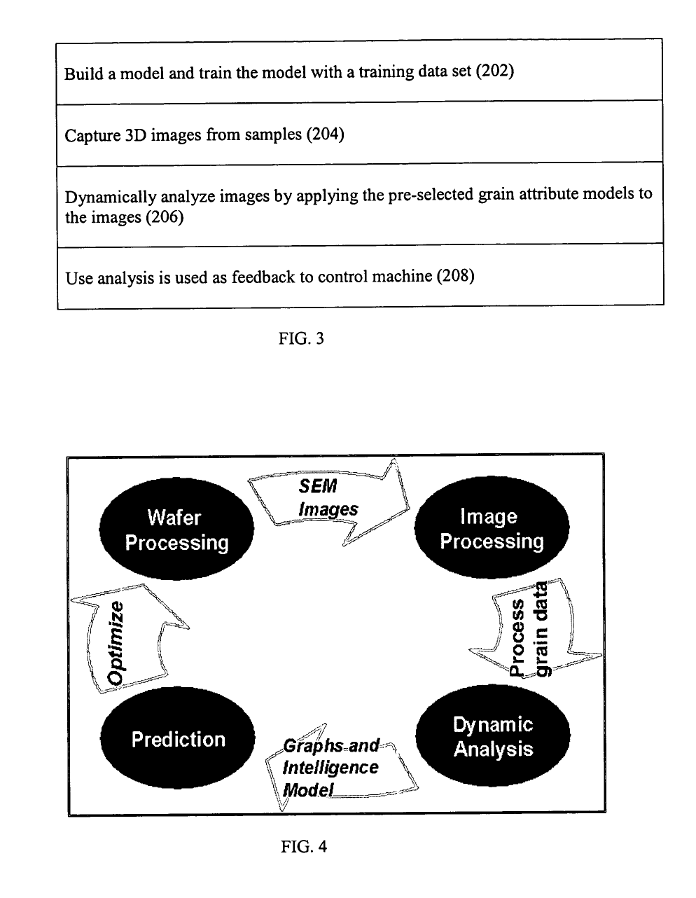

The method of FIG. 2 allows a user to identify attributes that are of interest. These attributes can then be used to dynamically analyze the images and provide real-time control of manufacturing equipment, among others. FIG. 3 illustrates an exemplary method 200 to dynamically analyze sample images. First, a model is built and trained using a training data set and one or more preselected grain attribute models (202).

In the 3D embodiment, the computation of an elevation model is done as follows. Based on the capture of two images in the SEM by tilting the object (or wafer), the process automatically determines corresponding points in these two images. Together with the calibration parameters (working distance, pixel size and tilt angle) the process reconstructs the topography or the specimen object (such as the wafer).

The training data set may be generated using the image processing method 100, and the training data set can be generated by a computer stand-alone or with an expert who determines the data set and an expected result. After training, the model is set to run dynamically on new samples, in this case on wafers that are being fabricated. Images are captured from samples during fabrication or during operation (204), and an analysis is performed by applying the pre-selected grain attribute models to the images (206). The output of the analysis is used as feedback to control a machine (208). In one embodiment, the analysis of the grain information is stored in tabular format, text delimited files, spreadsheet (Excel) files or database.

FIG. 4 shows an exemplary embodiment for semiconductor defect control. Manufacturing processes for submicron integrated circuits require strict process control for minimizing defects on integrated circuits. Defects are the primary “killers” of devices formed during manufacturing, resulting in yield loss. Hence, defect densities are monitored on a wafer to determine whether a production yield is maintained at an acceptable level, or whether an increase in the defect density creates an unacceptable yield performance.

The system of FIG. 4 takes SEM (Scanning Electron Microscope) images of wafers (300) and perform image processing (302) to generate grain data (304). The wafer is mounted on a stage. The stage is constructed so that it can be moved in the longitudinal direction, in the lateral direction and in the height direction which is the upper-and-lower direction. To allow the stage to be movable in these directions, the stage is provided with drive mechanisms each having a pulse motor (stepping motor) and the like. A processing computer gives instructions to a pulse motor controller to move and stop the stage at a predetermined position. Then, there is procured an image of the sample. Thereafter, the image data is subjected to image processing at the image processing method 100 and the computer to measure (calculate) and estimate the distribution, number, shape, density and the like of defects or imperfections contained in or on the wafer. After the end of the process, the stage with the sample mounted thereon is moved to the next position for measurement whereupon the sample in the stationary state is subjected to the same processes as above thereby to measure and evaluate the defects of the wafer sample. In one embodiment, SEM images can be taken by a low voltage SEM system, for example a JEOL 7700 or 7500 model. Additionally, the system of FIG. 4 can include an optical defect review system such as a Leica MIS-200, or a KLA 2608. The defect review system is used to complement the SEM system for throughput, and may also be used to review defects that are not visible under the SEM system, for example a previous layer defect. Dynamic analysis is run (306) and graphs and intelligence models are generated (308). Based on the model, predictions can be made (310). The model can be optimized (312) and the optimization can be applied to enhance wafer processing yield (316).

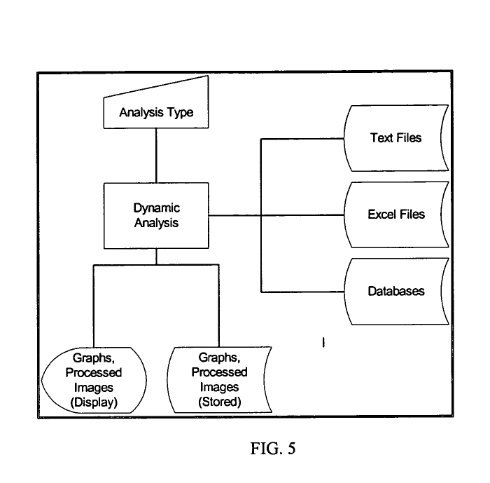

In one embodiment, the system performs dynamic analysis by allowing the user to specify one or more sampling windows for analysis. FIG. 5 shows an exemplary user interface with three selected sample areas of 500×500 squared nanometers. The system dynamically runs the analysis and processes the sample areas based on user's input. The system then calculates and stores grain's attributes in database or files.

Exemplary analysis and characterization of the sample in this case include:
Sum of perimeters of sample area (i.e. 500×500 nm²): the total perimeter of grains and sub-grains in sample area
Grain area ratio of (500×500 nm²): the ratio of total area of grains in a sample.
Spacing information of (500×500 nm²): the ratio of total area of space (on the image) in a sample (500×500 nm²)

In addition to storing data, the system provides visualization to facilitate pattern recognition and to allow process engineers to spot anomalies more rapidly. Various output formats ranging from tabular data display screens to graphical display screens are used to increase focus and attract the user's attention.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of an exemplary data processing system to perform dynamic analysis is shown in FIG. 5. FIG. 5 has a computer that preferably includes a processor, random access memory (RAM), a program memory (preferably a writable read-only memory (ROM) such as a flash ROM) and an input/output (I/O) controller coupled by a CPU bus. Computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

The system of FIG. 5 receives user input (analysis type), runs the analysis through the dynamic analysis method described above, stores the raw data as well as the resulting output, and generates various visualization screens. The processed data is stored in the disk drive in one or more data formats, including Excel format, Word format, database format or plain text format.

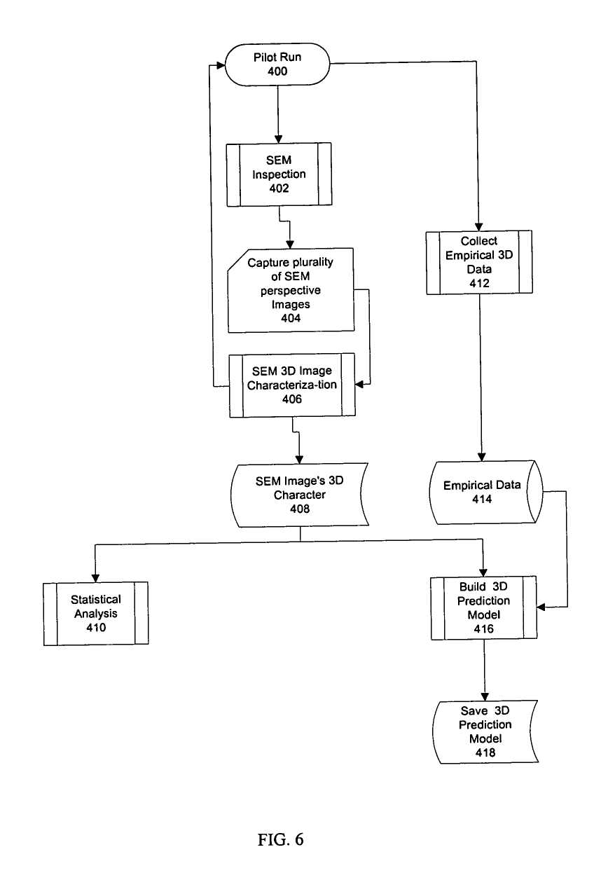

FIG. 6 shows an exemplary system to build a model. First, a Pilot Run is processed (400). Next, an inspection of the pilot run is done (402). Images such as SEM images are extracted (404). The image is characterized, as discussed above (406). If not acceptable, another batch from the pilot run is selected and operations 402-406 are repeated. If acceptable, the characteristics of the images are stored (408) for subsequent statistical analysis (410) or for building a prediction model (416). Also, from the pilot run, empirical data is collected (412) and stored (414). The characterized image data and the empirical data is used to build the prediction model in 416, and the resulting prediction model is stored for subsequent application, for example to perform process control.

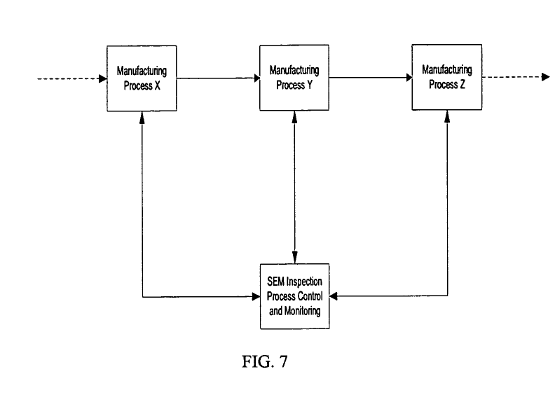

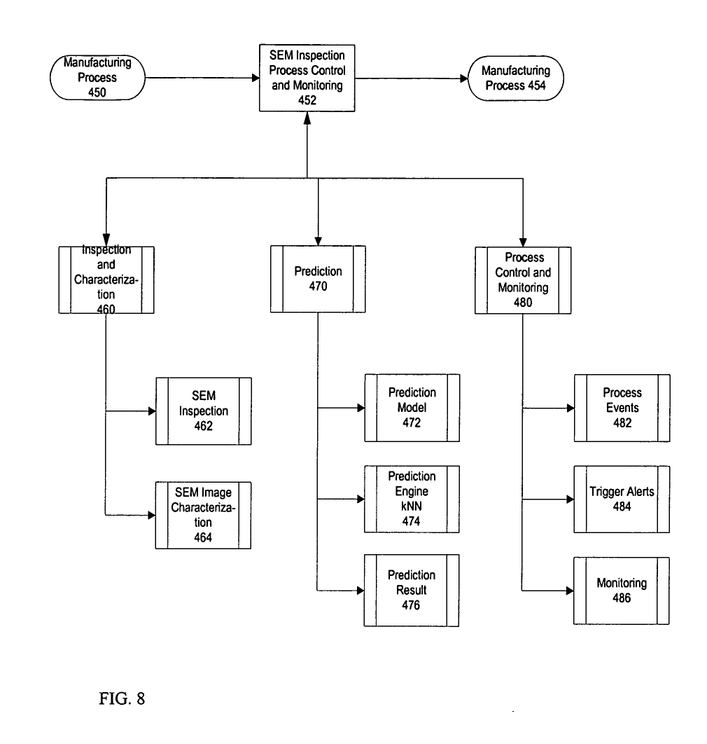

FIG. 7 shows an exemplary system that applies a model to perform process control. A plurality of manufacturing processes X, Y and Z are controlled by a SEM Inspection Process Control and Monitoring system, one embodiment of which is shown in FIG. 8.

In the illustrated embodiment, the SEM inspection process control/monitor system is a computer programmed with software to implement the functions described. However, as will be appreciated by those of ordinary skill in the art, a hardware controller designed to implement the particular functions may also be used.

An exemplary software system capable of being adapted to perform the functions of the automatic process control is the ObjectSpace Catalyst system offered by ObjectSpace, Inc. The ObjectSpace Catalyst system uses Semiconductor Equipment and Materials International (SEMI) Computer Integrated Manufacturing (CIM) Framework compliant system technologies and is based the Advanced Process Control (APC) Framework. CIM (SEMI E81-0699—Provisional Specification for CIM Framework Domain Architecture) and APC (SEMI E93-0999—Provisional Specification for CIM Framework Advanced Process Control Component) specifications are publicly available from SEMI.

In the system of FIG. 8, an image-based process control and monitoring module 452 is performed between manufacturing processes 450 and 454. The image-based process control and monitoring module 452 includes an image-based inspection and characterization module 460, a prediction module 470 and a process control and monitoring module 480. The inspection and characterization module 460 in turn includes modules to perform image inspection (462) and image characterization (464), which is discussed above.

The prediction module 470 in turn includes a module 472 containing one or more prediction models. In one embodiment, the models are generated using the system of FIG. 7. The module 470 also includes a prediction engine 474. The module 470 stores results generated by the prediction engine 474 in a prediction result store module 476.

In one embodiment, the prediction module 474 is a k-Nearest-Neighbor (kNN) based prediction system. The prediction can also be done using Bayesian algorithm, support vector machines (SVM) or other supervised learning techniques. The supervised learning technique requires a human subject-expert to initiate the learning process by manually classifying or assigning a number of training data sets of image characteristics to each category. This classification system first analyzes the statistical occurrences of each desired output and then constructs a model or “classifier” for each category that is used to classify subsequent data automatically. The system refines its model, in a sense “learning” the categories as new images are processed.

Alternatively, unsupervised learning systems can be used. Unsupervised Learning systems identify both groups, or clusters, of related image characteristics as well as the relationships between these clusters. Commonly referred to as clustering, this approach eliminates the need for training sets because it does not require a preexisting taxonomy or category structure.

Rule-Based classification can also be used where Boolean expressions are used to categorize significant output conditions. This is typically used when a few variables can adequately describe a category. Additionally, manual classification techniques can be used. Manual classification requires individuals to assign each output to one or more categories. These individuals are usually domain experts who are thoroughly versed in the category structure or taxonomy being used.

The process control and monitoring module 480 includes a module 482 that processes events, a module 484 that triggers alerts when one or more predetermined conditions are satisfied, and a module 486 that monitors predetermined variables.

An exemplary operation of the system of FIG. 8 is discussed next. The process control and monitoring module 480 receives a showerhead age input and/or an idle time input, either manually from an operator or automatically from monitoring a processing tool using the module 486. Based on the input parameters, the process control and monitoring module 480 consults a model 472 of the performance of the processing tool to determine recipe parameters for the control temperature, maximum ramp parameter, and ramp rate to account for predicted deposition rate deviations.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method to characterize a sample, comprising:
capturing a plurality of perspective images of the sample;
dividing the perspective images into one or more sub-lines; and
three-dimensionally characterizing the sample based on the sub-line analysis.

2. The method of claim 1, wherein the characterizing the sample further comprises:
extracting pixel values on a line of the sample;
storing the pixel values in a matrix corresponding to pixel's coordinate;
determining an average edge line for the pixel; and
determining grain characteristic of the line based on the pixel value and the average edge line.

3. The method of claim 1, further comprising performing spatial calibration.

4. The method of claim 1, further comprising determining a line distance after the spatial calibration.

5. The method of claim 1, further comprising determining an average edge line using edge line detection.

6. The method of claim 1, further comprising converting each pixel value on the line to a gray-scale value.

7. The method of claim 1, wherein the grain characteristic further comprises one of Area, Perimeter, Roundness, Elongation, Feret Diameter, Compactness, Major Axis Length, Major Axis Angle, Minor Axis Length, Minor Axis Angle, Centroid, and Height.

8. The method of claim 1, further comprising building a model.

9. The method of claim 8, further comprising:
collecting empirical data;
extracting training images
determining grain characteristics of the training images; and
generating a prediction model.

10. The method of claim 1, further comprising
building a model and training the model with a training data set;
capturing images from samples;
dynamically analyzing images by applying the trained model to the captured images; and
providing the analysis as feedback to control a machine.

11. A method to characterize an image of a sample, comprising:
extracting grain attributes from the image;
performing dynamic analysis on the grain attributes;
providing results using a graphical interface; and
generating one or more models to characterize the sample.

12. An image-based process control and monitoring system, comprising:
an image-based characterization module to characterize an object in 3D;
a prediction module coupled to the image-based characterization module including:
one or more prediction models;
a prediction engine coupled to the prediction models; and
a data storage unit coupled to the prediction engine to store predicted outputs; and
a process control and monitoring module to process events and trigger alerts when one or more predetermined conditions are satisfied.

13. The system of claim 12, further comprising a camera to capture images.

14. The system of claim 13, wherein the images are SEM images.

15. The system of claim 12, wherein the prediction model is kNN.

16. The system of claim 12, wherein the grain characteristic further comprises one of Area, Perimeter, Roundness, Elongation, Feret Diameter, Compactness, Major Axis Length, Major Axis Angle, Minor Axis Length, Minor Axis Angle, Centroid, and Height.
